(19) United States
(12) Patent Application Publication
(10) Pub. No.: US 2021/0329416 A1
(43) Pub. Date: Oct. 21, 2021

(54) Method and Apparatus for Location Services

(71) Applicant: Telefonaktiebolaget LM Ericsson (PUBL), Stockholm (SE)

(72) Inventors: Tianyi Li, Shanghai (CN); Di SHU, Shanghai (CN)

(21) Appl. No.: 17/271,315

(22) PCT Filed: Aug. 30, 2018
(86) PCT No.: PCT/CN2018/103235

§ 371 Date: Feb. 25, 2021

(51) Int. Cl. H04W 4/029; H04B 17/318

(52) U.S. Cl. CPC H04W 4/029; H04B 17/318

(57) ABSTRACT

A method for positioning is proposed. The method which may be implemented in a network node comprises obtaining first measurement information for positioning a terminal device. The method further comprises identifying a match with the first measurement information from reference data. The reference data comprises, for each of a plurality of predefined locations, second measurement information which is collected for a reference device by using multi-antenna technology. The method further comprises determining a three-dimensional position of the terminal device, based at least in part on the second measurement information matched with the first measurement information.

### FIELD OF THE INVENTION

The present disclosure generally relates to communication networks, and more specifically, to location services (LCS) in a communication network.

### BACKGROUND

This section introduces aspects that may facilitate a better understanding of the disclosure. Accordingly, the statements of this section are to be read in this light and are not to be understood as admissions about what is in the prior art or what is not in the prior art.

Mobile broadband. may continue to drive some demands for big overall traffic capacity and huge achievable end-user data rates in a wireless communication network. Many scenarios for network services in the future may require data rates of up to 10 Gbps in local areas. These demands for very high system capacity and. end-user data rates can be met by networks where distances between access nodes may range from a few meters in indoor deployments up to roughly 50 meters in outdoor deployments, for example, by next generation communication networks with an infrastructure density considerably higher than the densest networks of today. With the rapid development of networking and radio technologies such as an Internet of things (IoT), the next generation communication networks such as fifth generation (5G) and new radio (NR) may accommodate not only human handsets, but also machines and sensors. Some communication applications may request location services (LCS) to acquire the accurate location of a terminal device such as an enhance mobile broadband (eMBB) terminal or an IoT terminal in the network. However, the performance of LCS may be affected due to network environments and communication capabilities of terminal devices. Thus, it may be desirable to provide the LCS with greater energy efficiency and improved accuracy for terminal devices with different capabilities under various network environments.

### SUMMARY

This summary is provided to introduce a selection of concepts in a simplified form that are further described below in the detailed description. This summary is not intended to identify key features or essential features of the claimed subject matter, nor is it intended to be used to limit the scope of the claimed subject matter.

With the deployment of a long term evolution (LTE) network and net evolution to NR, the IoT devices increasingly call for high reliability, deep coverage and massive connectivity, accordingly the IoT devices tend to have limited capability, deployed in deep locations and require less power usage. On the other hand, the eMBB terminals may demand more accurate LCS in dense traffic scenarios, such as dense urban, high mansion, etc. Considering the indoor scenarios where the assisted global positioning system (GPS) signals are less detectable, the accurate positioning of eMBB and IoT terminals would become more challenging.

The present disclosure proposes a solution for LCS in a communication network, which can enable a network node such as a location server to determine a three-dimensional (3D) position of a terminal device by utilizing multi-antenna technology, so that more accurate positioning of the terminal device (such as an. eMBB/IoT terminal) can be provided with improved energy efficiency and user experience under various network environments.

According to a first aspect of the present disclosure, there is provided a method implemented at a network node. The method may comprise obtaining first measurement information for positioning a terminal device. The method may further comprise identifying a match with the first measurement information from reference data. The reference data may comprise, for each of a plurality of predefined locations, second measurement information which is collected for a reference device by using multi-antenna technology. The method may further comprise determining a 3D position of the terminal device, based at least in part on the second measurement information matched with the first measurement information.

In accordance with an exemplary embodiment, for each of the plurality of predefined locations, the reference data may indicate corresponding 3D position coordinates and the second measurement information may comprise signal strength information and beam information related to the reference device.

In accordance with an exemplary embodiment, the terminal device may be configured to support multi-antenna communication. In this case, the first measurement information may comprise signal strength information and beam information reported by the terminal device.

In accordance with an exemplary embodiment, the terminal device may be configured to support machine type communication with a serving cell. In this case, the first measurement information may comprise signal strength information and beam information which can be generated by the network node according to measurements of the terminal device.

In accordance with an exemplary embodiment, the network node can obtain the first measurement information by determining compensations for the measurements of the terminal device, based at least in part on signal strength information and beam information reported by one or more neighboring devices of the terminal device in the serving cell. The network node can generate the first measurement information by applying the compensations to the measurements of the terminal device.

In accordance with an exemplary embodiment, the network node can identify the second measurement information matched with the first measurement information by calculating, for at least one of the plurality of predefined locations, a similarity between the second measurement information and the first measurement information. The network node can determine the second measurement information matched with the first measurement information, based at least in part on a result of the calculation.

In accordance with an exemplary embodiment, the 3D position of the terminal device may be indicated by 3D position coordinates which are corresponding to the second measurement information matched with the first measurement information.

In accordance with an exemplary embodiment, the terminal device may be configured to support device-to-device (D2D) communication with one or more candidate devices which are configured to support multi-antenna communication with a serving cell. Optionally, any of the one or more candidate devices may be operated as a relay to enable the terminal device to communicate with the serving cell.

In accordance with an exemplary embodiment, the first measurement information may comprise one or more groups of measurements and each group of measurements may comprise signal strength information and beam information reported by a candidate device being selected from the one or more candidate devices.

In accordance with an exemplary embodiment, the network node can obtain the first measurement information by sending to the serving cell a request for positioning the terminal device. The request can enable the serving cell to trigger the D2D communication between the terminal device and the selected candidate device and the report of signal strength information and beam information to the serving cell by the selected candidate device. The network node can receive the first measurement information from the serving cell.

In accordance with an exemplary embodiment, the network node can identify the second measurement information matched with the first measurement information by calculating, for at least one of the plurality of predefined locations, a similarity between the second measurement information and each group of measurements in the first measurement information. The network node can determine the second measurement information matched with each group of measurements in the first measurement information, based at least in part on a result of the calculation.

In accordance with an exemplary embodiment, the network node can determine the 3D position of the terminal device by getting, from the reference data, 3D position coordinates which are corresponding to the second measurement information matched with each group of measurements. The network node may process the 3D position coordinates from the reference data according to a predefined criterion to derive the 3D position of the terminal device.

In accordance with an exemplary embodiment, the reference data may be maintained according to a sparse dictionary learning scheme.

In accordance with an exemplary embodiment, the network node can identify the second measurement information matched with the first measurement information by using a probabilistic graphical model.

In accordance with an exemplary embodiment, the reference data may be updated based at least in part on positioning measurements collected from one or more communication networks.

In accordance with an exemplary embodiment, the determination of the 3D position of the terminal device may be optimized according to two or more positioning algorithms.

According to a second aspect of the present disclosure, there is provided an apparatus. The apparatus may comprise one or more processors and one or more memories comprising computer program codes. The one or more memories and the computer program codes may be configured to, with the one or more processors, cause the apparatus at least to perform any step of the method according to the first aspect of the present disclosure.

According to a third aspect of the present disclosure, there is provided a computer-readable medium having computer program codes embodied thereon which, when executed on a computer, cause the computer to perform any step of the method according to the first aspect of the present disclosure.

According to a fourth aspect of the present disclosure, there is provided an apparatus. The apparatus may comprise an obtaining unit, an identifying unit and a determining unit. In accordance with some exemplary embodiments, the obtaining unit may be operable to carry out at least the obtaining step of the method according to the first aspect of the present disclosure. The identifying unit may be operable to carry out at least the identifying step of the method according to the first aspect of the present disclosure. The determining unit may be operable to carry out at least the determining step of the method according to the first aspect of the present disclosure.

### BRIEF DESCRIPTION OF THE DRAWINGS

The disclosure itself, the preferable mode of use and further objectives are best understood by reference to the following detailed description of the embodiments when read in conjunction with the accompanying drawings, in which:

FIG. 1 is a diagram illustrating an example of communication coverage according to some embodiments of the present disclosure;

FIG. 2 is a flowchart illustrating an exemplary positioning process according to some embodiments of the present disclosure;

FIG. 3A is a diagram illustrating an example of angular coverage according to Male embodiments of the present disclosure;

FIGS. 3B-3C are diagrams illustrating exemplary radio configurations according to some embodiments of the present disclosure;

FIG. 4 is a flowchart illustrating an exemplary procedure for IRS according to some embodiments of the present disclosure;

FIG. 5 is a flowchart illustrating an exemplary procedure of processing a location request according to some embodiments of the present disclosure;

FIG. 6A is a diagram illustrating an exemplary scenario for positioning a terminal device with D2D communication capability according to some embodiments of the present disclosure;

FIG. 6B is a diagram illustrating an exemplary signaling procedure for positioning a terminal device with D2D communication capability according to some embodiments of the present disclosure;

FIG. 7 is a diagram illustrating an exemplary scenario for positioning a terminal device without D2D communication capability according to some embodiments of the present disclosure;

FIG. 8 is a flowchart illustrating a method according to some embodiments of the present disclosure;

FIG. 9 is a block diagram illustrating an apparatus according to some embodiments of the present disclosure; and

FIG. 10 is a block diagram illustrating another apparatus according to some embodiments of the present disclosure.

### DETAILED DESCRIPTION

The embodiments of the present disclosure are described in detail with reference to the accompanying drawings. It should be understood that these embodiments are discussed only for the purpose of enabling those skilled persons in the art to better understand and thus implement the present disclosure, rather than suggesting any limitations on the scope of the present disclosure. Reference throughout this specification to features, advantages, or similar language does not imply that all of the features and advantages that may be realized with the present disclosure should be or are in any single embodiment of the disclosure. Rather, language referring to the features and advantages is understood to mean that a specific feature, advantage, or characteristic described in connection with an embodiment is included in at least one embodiment of the present disclosure. Furthermore, the described features, advantages, and characteristics of the disclosure may be combined in any suitable manner in one or more embodiments. One skilled in the relevant art will recognize that the disclosure may be practiced without one or more of the specific features or advantages of a particular embodiment. In other instances, additional features and advantages may be recognized in certain embodiments that may not be present in all embodiments of the disclosure.

As used herein, the term “communication network” refers to a network following any suitable communication standards, such as new radio (NR), long term evolution (LTE), LTE-Advanced, wideband code division multiple access (WCDMA), high-speed packet access (HSPA), and so on. Furthermore, the communications between a terminal device and a network node in the communication network may be performed according to any suitable generation communication protocols, including, but not limited to, the first generation (1G), the second generation (2G), 2.5G, 2.75G, the third generation (3G), 4G, 4.5G, 5G communication protocols, and/or any other protocols either currently known or to be developed in the future.

The term “network device” refers to a radio device in a communication network via which a terminal device accesses to the network and receives services therefrom. The network device may refer to a base station (BS), an access point (AP), a multi-cell/multicast coordination entity (MCE), a controller or any other suitable device in a wireless communication network. The BS may be, for example, a node B (NodeB or NB), an evolved NodeB (eNodeB or eNB), a next generation NodeB (gNodeB or gNB), a remote radio unit (RRU), a radio header (RH), a remote radio head (RRH), a relay, a low power node such as a femto, a pico, and so forth.

Yet further examples of the network device comprise multi-standard radio (MSR) radio equipment such as MSR BSs, network controllers such as radio network controllers (RNCs) or base station controllers (BSCs), base transceiver stations (BTSs), transmission points, transmission nodes, positioning nodes and/or the like. More generally, however, the network device may represent any suitable device (or group of devices) capable, configured, arranged, and/or operable to enable and/or provide a terminal device access to a wireless communication network or to provide some service to a terminal device that has accessed to the wireless communication network.

The term “terminal device” refers to any end device that can access a communication network and receive services therefrom. By way of example and not limitation, the terminal device may refer to a mobile terminal, a user equipment (UE), or other suitable devices. The UE may be, for example, a subscriber station, a portable subscriber station, a mobile station (MS) or an access terminal (AT). The terminal device may include, but not limited to, portable computers, image capture terminal devices such as digital cameras, gaming terminal devices, music storage and playback appliances, a mobile phone, a cellular phone, a smart phone, a tablet, a wearable device, a personal digital assistant (PDA), a vehicle, and the like.

As yet another specific example, in an Internet of things (IoT) scenario, a terminal device may also be called an IoT device and represent a machine or other device that performs monitoring, sensing and/or measurements etc., and transmits the results of such monitoring, sensing and/or measurements etc. to another terminal device and/or a network equipment. The terminal device may in this case be a machine-to-machine (M2M) device, which may in a 3rd generation partnership project (3GPP) context be referred to as a machine-type communication (MTC) device.

As one particular example, the terminal device may be a UE implementing the 3GPP narrow band Internet of things (NB-IoT) standard. Particular examples of such machines or devices are sensors, metering devices such as power meters, industrial machinery, or home or personal appliances, e.g. refrigerators, televisions, personal wearables such as watches etc. In other scenarios, a terminal device may represent a vehicle or other equipment, for example, a medical instrument that is capable of monitoring, sensing and/or reporting etc. on its operational status or other functions associated with its operation.

As used herein, the terms “first”, “second” and so forth refer to different elements. The singular forms “a” and “an” are intended to include the plural forms as well, unless the context clearly indicates otherwise. The terms “comprises”, “comprising”, “has”, “having”, “includes” an for “including” as used herein, specify the presence of stated features, elements, and/or components and the like, but do not preclude the presence or addition of one or more other features, elements, components and/or combinations thereof. The term “based on” is to be read as “based at least in part on”. The term “one embodiment” and “an embodiment” are to be read as “at least one embodiment”. The term “another embodiment” is to be read as “at least one other embodiment”. Other definitions, explicit and implicit, may be included below.

Wireless communication networks are widely deployed to provide various telecommunication services such as voice, video, data, messaging and broadcasts. To meet dramatically increasing network requirements on traffic capacity and data rates, one interesting option for communication technique development is to employ multi-antenna technology in a wireless communication network such as a 4G/56 network. Multi-antenna technology brings significant improvements in system performance and energy efficiency by focusing the transmission and reception of signal energy into ever-smaller regions of space. Basically, the more antennas the transmitter/receiver is equipped with, the more the possible signal paths and the better the performance in terms of data rate and link reliability.

Through the use of a large number of service antennas (e.g., hundreds or thousands) which are operated fully coherently and adaptively, the multi-antenna technology such as massive multiple-input multiple-output (MIMO) can bring prominent improvements in data throughput and energy efficiency, particularly when MIMO is combined with simultaneous scheduling of a large number of user terminals (e.g., tens or hundreds). In general, MIMO can be used for the time division duplex (TDD) operation, but it may also be potentially applied in the frequency division duplex (FDD) operation.

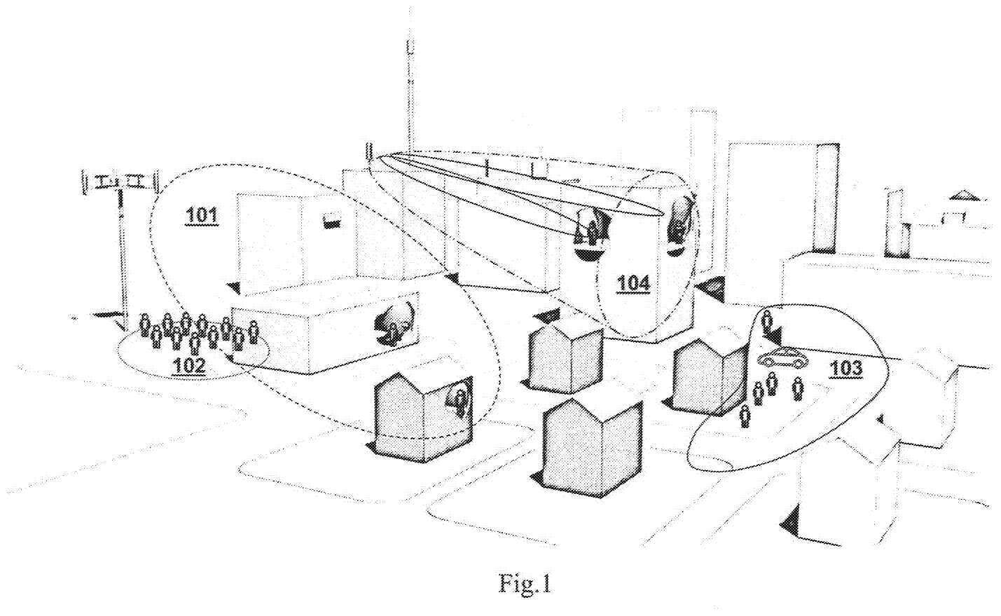

FIG. 1 is a diagram illustrating an example of communication coverage according to some embodiments of the present disclosure. The example shown in FIG. 1 may be applicable to a NR scenario where massive MIMO is implemented to bring coverage improvement. It will be appreciated that there may be other scenarios where the communication network may apply or support various radio interface technologies which are not limited to LTE and NR technologies. For simplicity, FIG. 1 only depicts some exemplary focus areas such as a legacy LTE system 101, a hotspot 102, a cell shaping area 103 and a high rise building 104.

As the capacity and coverage extension solution, massive MIMO can bring about 10˜20 dB coverage gain which may depend on advanced antenna system (AAS) power setting, antenna pattern and pathloss in the specific scenario. This coverage gain can help the fingerprints of eMBB terminals get close to consistency of link budget. In addition to the coverage enhancement, other benefits may also be achieved by applying MIMO in a wireless communication network, for example, large data throughput, the extensive use of inexpensive low-power components, reduced latency, simplification of the media access control (MAC) layer, and robustness to interference and intentional jamming.

In the scenario described in connection with FIG. 1, various terminals such as eMBB and IoT devices can be connected to a network with different radio access technologies and obtain services such as LCS from the network. Several position determination algorithms of varying accuracy and complexity, such as cell identifier (ID) positioning and fingerprinting positioning, may be applicable for positioning the terminal devices in the network. The fingerprinting positioning algorithm can provide an accuracy somewhere in between the high precision positioning algorithm and the enhanced cell ID (ECID) positioning algorithm.

In accordance with an exemplary embodiment, the fingerprinting positioning algorithm can operate by creating a radio reference fingerprint (or simply reference fingerprint) for each point of a fine coordinate grid that covers a radio access network (RAN). For example, the reference fingerprint may comprise: the cell IDs that are detected by a UE in each grid point; and quantized pathloss or signal strength (SS) measurements, with respect to multiple cells, performed by the UE in each grid point. Optionally, the reference fingerprint may also comprise the quantized timing advance in each grid point, and/or an associated ID of the cell.

According to the fingerprinting positioning algorithm, a reference fingerprint is first measured in response to a position request. Then the corresponding grid point is looked up and reported. This may require that the point is unique. In order to conduct the positioning of a terminal device, the signal information received from the terminal device (for which the fingerprint is requested) is compared to the pre-measured signal information of reference fingerprints, and then the location of the best matching reference fingerprint may be returned as a result of the positioning.

In the complicated communication environments such as indoor and/or dense traffic scenarios, the accuracy of positioning algorithms may be affected by radio signal interference and limited device capability. On the other hand, due to massive connection and deep coverage criterions, IoT terminals may have little opportunity of getting the positioning service from Bluetooth/WiFi/Beacon APs. However, it is beneficial to build a simple NB/eMTC positioning fingerprint database via NR-LTE dual cell (DC) terminals in massive MIMO, meanwhile there is no additional power cost for the IoT terminals served by LTE.

The proposed solution according to some exemplary embodiments may be applicable to the complicated LCS scenarios to achieve power-saving 3D-fingerprint of passive location. The positioning approach in accordance with the proposed solution may be compatible with AAS deployment where the GPS may be unavailable for IoT devices. In accordance with some exemplary embodiments, massive MIMO can provide a new dedicated way for beam managements and location. For example, the 3D-fingerprint extraction and data processing with machine learning may be utilized to implement the LCS. Optionally, location feature cognition and sparse matrix processing acceleration may also be used for provision of the LCS. In the case that most of NB-IoT and CAT-M terminals are legacy terminals in LIE and unavailable for beam measurement report, the high density of spectrum character in signal strength are close to the eMBB terminal fingerprint in massive MIMO. Therefore, it may be favorable to use the eMBB terminal fingerprint in a database to achieve the more accurate LCS.

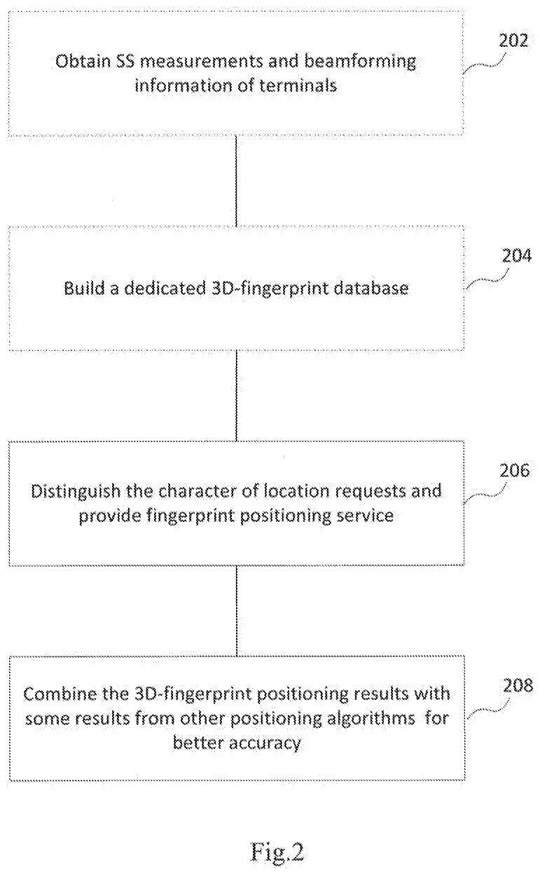

FIG. 2 is a flowchart illustrating an exemplary positioning process according to some embodiments of the present disclosure. The exemplary positioning process illustrated in FIG. 2 can be performed in a communication network which may comprise a location server, at least one base station, and one or more terminal devices. The location server can distinguish the characters of location requests and provide fingerprint positioning services, as shown in block 206, for example, by using different databases and algorithms. In accordance with some exemplary embodiments, the location server can provide the 3D-fingerprint positioning service to a terminal device by retrieving location information of the terminal device from one or more 3D location databases. Optionally, the location server may build a dedicated 3D-fingerprint/location database, for example, based at least in part on the SS measurements and beamforming information provided to the network by the terminal devices, as shown in block 202 and block 204. The beamforming information (or simply beam information) may be related to the static beam deployed in NR and LTE networks, for example, especially for synchronization signal/physical broadcast channel block (SS/PBCH block or simply SSB), channel state information-reference signal (CSI-RS), common reference signal (CRS) and control channel. It will be appreciated that the 3D-fingerprint database may also be set up by another network entity or device with various suitable data collection and processing approaches. In order to achieve better accuracy of positioning, as shown in block 208, the location server may combine the 3D-fingerprint positioning results with some results from other positioning algorithms such as ECID, time difference of arrival (TDOA), etc.

In accordance with some exemplary embodiments, a fingerprint positioning estimation is typically preceded by creating a database of reference fingerprints in a network node (e.g., a location server or a logical integrated network element (NE), distributed or centralized deployed). The reference fingerprints in the database may for example comprise: ground truth (e.g., longitude, latitude and altitude); the cell IDs that are detected by a terminal in each grid point; the quantized signal strength measurement and signal to interference plus noise ratio (SINR), with respect to multiple cells, performed by the terminal in each grid point; the quantized timing advance in each grid point and optionally an associated ID of the cell.

In next generation radio access network (NG-RAN) or evolved-universal terrestrial radio access network (E-URTAN) scenario, the location management function/serving mobile location center (LMF/SMLC) can get the exact beam information from a terminal measurement report. For example, a UE in the RRC_CONNECTED status can derive cell measurement results by measuring one or multiple beams associated per cell as configured by the network. For cell measurements, the network can configure reference signal received power (RSRP), reference signal received quality (RSRQ) or SINR as trigger quantity. Reporting quantities can be the same as trigger quantity or combinations of quantities (such as RSRP and RSRQ; RSRP and SINR; RSRQ and SINR; RSRP, RSRQ and SINR). Alternatively or additionally, the network may also configure the UE to report measurement information per beam, which can either be measurement results per beam with respective beam identifiers or only beam identifier(s).

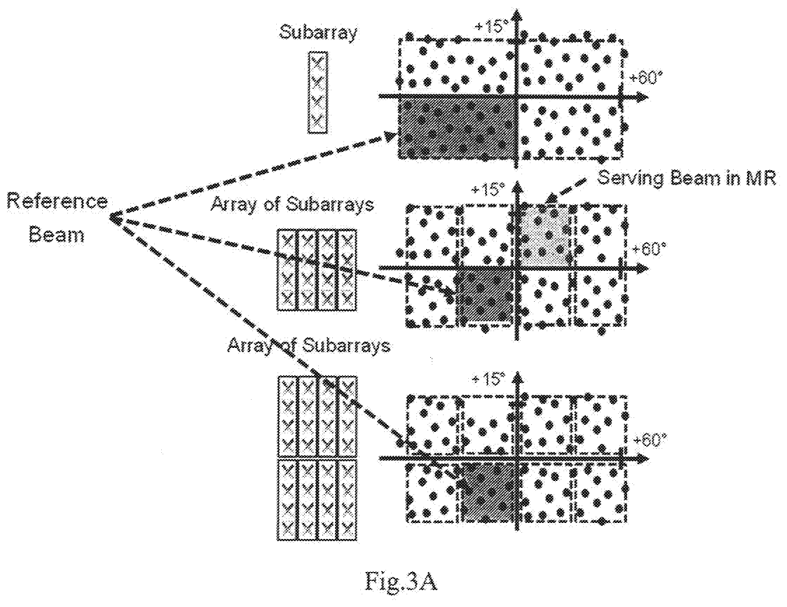

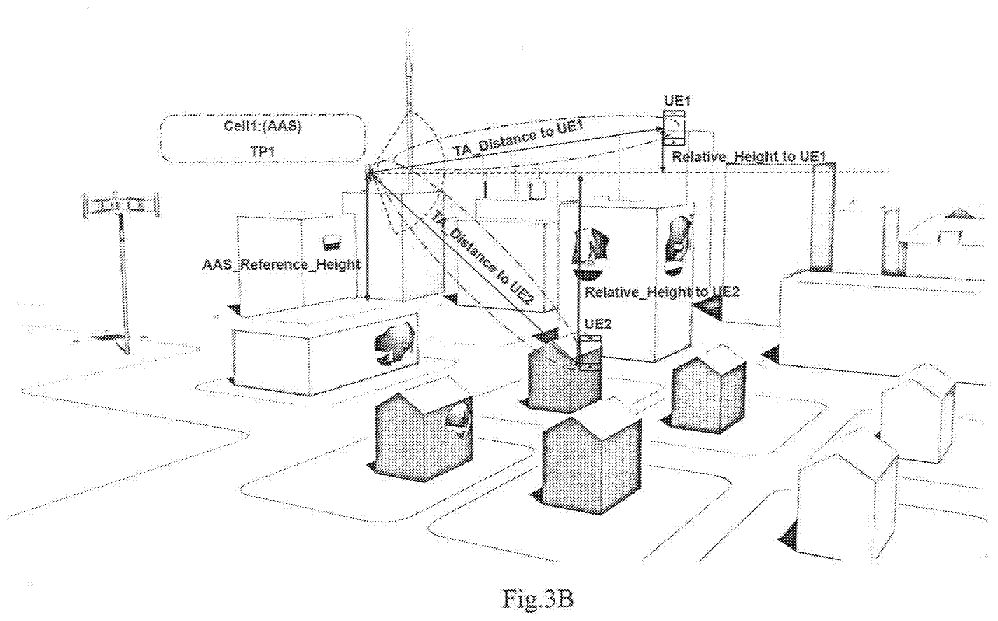

FIG. 3A is a diagram illustrating an example of angular coverage according to some embodiments of the present disclosure. The example shown in FIG. 3A may be applicable to a LTE or NR scenario where the reference beam and beam width as well as beam ID can be marked in advance with RAN antenna deployment. FIG. 3A shows some examples of reference beam in angular coverage with different deployments of antenna array or subarray. For example, the serving beam in a MR of a terminal device can be compared to the reference beam so that the position of the terminal device in the antenna. coverage can be determined roughly. In accordance with some exemplary embodiments, by collecting the radio resource control (RRC) measurements, the location server can get the height from the reference height or a beam angle corresponding to a reference beam angle, such as angle of arrival (AOA) without dedicated measurements from baseband of RAN. All of these can mitigate the capacity and processing bottleneck of baseband, meanwhile, height information may be available easily. Then, the coordinates of a terminal device may be stored in the database by taking the AAS antenna 3D-coordinates as follows:

| | |
|---|---|
| Measurement ID: | . . . |
| Cell ID: | X |
| Beam ID: | Y |
| TP ID/AAS ID: | Z |
| TP GNSS Lat Log: | (zm, zn) |
| Angle to reference beam with 2 direction: | (+15, +15) |
| GNSS Lat Log: | (m, n) |
| Timestamp: | . . . |
| TA: | . . . |
| SS: | RSRP, RSRQ, |
| | SINR, etc. |

FIGS. 3B-3C are diagrams illustrating exemplary radio configurations according to some embodiments of the present disclosure. As illustrated in FIG. 3B, UE1 and UE2 may be served by Cell1 at transmission point 1 (TP1) where AAS is deployed. FIG. 3B schematically shows, in the vertical direction, the reference height of AAS (which is indicated by AAS_Reference_Height) at TP1, the time advance (TA) distance (which is indicated by TA_Distance) from TP1 to UE1/UE2, and the relative height (which is indicated by Relative_Height) of TP1 to UE1/UE2. FIG. 3C schematically shows, in the horizontal direction, the relative width (which is indicated by Relative_Width) of TP1 to UE1, and the TA distance (which is indicated by TA_Distance) from TP1 to UE1.

In the case that there is no AOA measurement report from the baseband, the height coordinate can be transformed as follows:

Measurement_Height=AAS_Reference_Height+Relative_Height (1)

Relative_Height/TA_Distance=sin (Vertical angle to reference beam) (2)

Relative_Width/TA_Distance=sin (Horizontal angle to reference beam) (3)

Relative_Deepth=TA_Distance (4)

Correspondingly, the fingerprints can be turned into a new format and optionally coexisted with those fingerprints including global navigation satellite system (GNSS) information. For example, the fingerprints can be stored in the database as follows:

| | |
|---|---|
| Measurement ID: | . . . |
| Cell ID: | X |
| Beam ID: | Y |
| TP ID/AAS ID: | Z |
| TP GNSS Lat Log: | (zm, zn) |
| Relative coordinate: | (Relative_Deepth, Relative_Width, |
| | Relative_Height) |
| GNSS Lat Log: | (m, n) |
| Timestamp: | . . . |
| TA: | . . . |
| SS: | RSRP, RSRQ, SINR, etc. |

In accordance with some exemplary embodiments, machine learning may be applied to the fingerprint database to implement predictive analytics. Machine learning is a field of computer science that often uses statistical techniques to give computers the ability to “learn” (i.e., progressively improve performance on a specific task) with data, without being explicitly programmed. Machine learning is closely related to (and often overlaps with) computational statistics, which also focuses on prediction-making through the use of computers. Within the field of data. analytics, machine learning may be used to devise complex models and algorithms that lend themselves to prediction. These analytical models allow analysts to “produce reliable, repeatable decisions and results” and uncover “hidden insights” through learning from historical relationships and trends in the data.

In accordance with some exemplary embodiments, sparse dictionary learning may be utilized to represent data stored in the fingerprint database. According to the sparse dictionary learning, a datum is represented as a linear combination of basic functions, and the coefficients are assumed to be sparse. Let Y be a d-dimensional datum, H be a d by l matrix (where each column of H represents a basis function), and q is the coefficient to represent Y using H. Mathematically, sparse dictionary learning means solving Y≈H q where q is sparse. Generally, l is assumed to be larger than d to allow the freedom for a sparse representation. Learning a dictionary along with sparse representations is strongly non-deterministic polynomial-hard (NP-hard) and also difficult to solve approximately. A popular heuristic method for the sparse dictionary learning is K-SVD.

Sparse dictionary learning may be applied in several contexts. For example, in classification, the problem is to determine which classes a previously unseen datum belongs to. Suppose a dictionary for each class has already been built. Then a new datum is associated with the class such that it's best sparsely represented by the corresponding dictionary. In the proposed positioning solution according to some exemplary embodiments, the sparse dictionary learning is introduced into historic wireless fingerprints, for example, including but not limited to signal strength, beam ID, relative height, relative coordinate, etc. As such, the clean position coordinates can be sparsely represented by a valid fingerprint dictionary without the noise.

In accordance with some exemplary embodiments, the learning machine is given pairs of examples that are considered similar and pairs of less similar objects. There is a need to learn a similarity function (or a distance metric function) that can predict if new objects are similar. It is sometimes used in recommendation systems. Assume that the SS vector of the with reference point (RP) from m serving cells/transmission points (TPs) is Rᵢ=(rᵢ¹, rᵢ², . . . , rᵢ^{j}, . . . , rᵢ^{m}) collected using a reference device to form the fingerprints in the database, and S=(s¹, s², . . . , s^{j}, . . . , s^{m}) is the SS vector received from m serving cells/TPs by a user's device at each measurement report (MR) location when the location service is requested for the user's device. Here, rᵢ^{j} and s^{j} may respectively represent the SS values of the ith RP and MR from jth TP, where j=1, 2, . . . , m. Optionally, the SS vectors of RP and MR may apply some or all of RSRP/RSRQ/SINR and/or beam information.

In accordance with some exemplary embodiments, the real coordinates of the RP locations are also included in the database. Then the SS vector got by the user's device may be compared with the fingerprints in the database to find the best match according to a predefined criterion. For example, the Euclidean distance may be used as the predefined criterion because of its simple principle and little amount of calculations. The Euclidean distance in the NR/LTE/WEAN/Bluetooth positioning system may refer to the similarity between the SS vectors of RP and MR in signal space rather than in the Euclidean space. For the ith RP, the Euclidean distance can be defined as:

$${D}_{i} = \sqrt{{\sum }_{j = m}^{1} {( {s}^{j} - {r}_{i}^{j} )}^{2}} \qquad ( 5 )$$

where i=1, 2, . . ., n (n is the total number of RPs), and Dᵢ is the signal distance between the SS vectors of RP and MR. The smaller the Dᵢ is, the shorter the distance between the SS vectors of MR and RP.

In accordance with some exemplary embodiments, the location of the user's device may be roughly predicted by using a probabilistic graphical model, so that the similarity results calculated by formula (5) can be filtered optimally. According to an exemplary embodiment, a Bayesian network, belief network or directed acyclic graphical model may be used as a probabilistic graphical model that represents a set of random variables and their conditional independencies via a directed acyclic graph (DAG). For example, the posterior probability is the probability of the parameters x:p(θ|x), a prior belief that the probability distribution function is p(θ) and observations x with the likelihood p(x|θ), then the posterior probability is defined as:

$$p ( θ \vert x ) = \frac{p ( x \vert θ ) p ( θ )}{p ( x )} \qquad ( 6 )$$

By converting SS and beam ID/beam coordinates into fingerprints, the database may have a prior probability of measurement in specific TP/cell/beam ID. Then a location request that characterizes observations x with the probability distribution function p(θ), can be represented by angle or height fingerprints via a beam and antenna as with RSRP/RSRQ/SINR in measurements. Based at least in part on the character of the location request for the user's device, the matched fingerprints can be found in the database according to the location probability estimated for the user's device. Optionally, the database may store some fingerprints dependent on LTE/3G/WLAN/Bluetooth fingerprint systems, so that the positioning is more reliable.

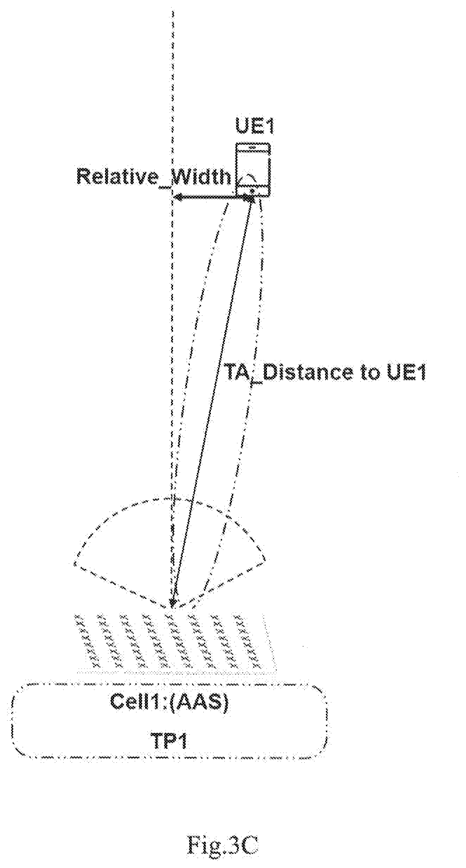

FIG. 4 is a flowchart illustrating an exemplary procedure for LCS according to some embodiments of the present disclosure. The exemplary procedure may be implemented at network side in a centralized or distributed manner. For example, the exemplary procedure may be performed by a location server to provide LCS for various terminal devices in a communication network. Optionally, fingerprint information for the LCS may be received or collected by one or more network devices such as eNB/gNB which can forward the collected fingerprint information to the location server. The location server can use the fingerprint information to implement the positioning of a terminal device.

According to the procedure as illustrated in FIG. 4, some measurements from a terminal device may be received for generating fingerprints, as shown in block 402. For example, the terminal device may perform measurement on SS and report the terminal measurements to the network according to network configurations. In accordance with some exemplary embodiments, the location server can collect some related beam information with the terminal measurements, as shown in block 404. Then the location server can transform the beam information into height axis or beam angle together with the two-dimensional (2D) fingerprints, as shown in block 406. The transformed information may be stored, for example, in a fingerprint database. Optionally, as shown in block 408, machine learning may be conducted for the 3D fingerprints and the probability distribution of terminal locations may also be generated to assist in positioning. In response to a location request, as shown in block 410, the location server can perform the corresponding process depending on the character of the location request, for example, the measurements associated with the location request and optionally the category of the terminal device for which the location request is initiated.

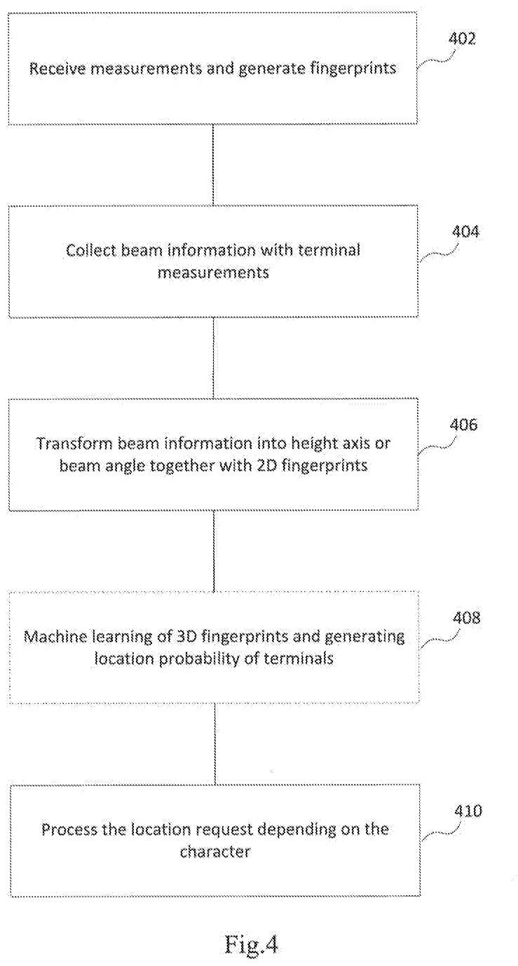

FIG. 5 is a flowchart illustrating an exemplary procedure of processing a location request according to some embodiments of the present disclosure. The exemplary procedure may be performed by a location server or any other network node such as LMF/SMLC which is able to process a location request for positioning a terminal device. According to the procedure as illustrated in FIG. 5, the location server may receive a location request for the terminal device, as shown in block 502. The location request may be transmitted to the location server in a MR of the terminal device. Alternatively, the location request may be initiated by the location server or any other suitable network node to acquire location information of the terminal device. In response to the location request, the location server may make a terminal category inquiry, as shown in block 504.

In accordance with an exemplary embodiment, the terminal category may be classified according to capability information of the terminal device. For example, the location server may obtain the capability information of the terminal device from other network device such as eNB or mobility management entity (MME). The capability information of the terminal device may be carried or indicated in an information element (IE) message such as UECapabilityInformation, UECapabilityInformation-NB, ue-RadioPagingInfo-r12, etc. As an example, the UECapabilityInformation message may be used to transfer UE radio access capabilities requested by the E-UTRAN. According to the indication of terminal category in the capability information, the location server can identify the terminal device of which the location is requested as a terminal device which can support MIMO communication, or a terminal device which does not support MIMO communication.

In the case that the location request is initiated for a terminal device such as an eMBB terminal which can support MIMO communication, as shown in block 506, the location server can perform positioning of the terminal device with 3D fingerprints directly. In accordance with an exemplary embodiment, the eMBB terminal can report measurements including beam information to the network. The location server can calculate the similarity between the measurements in the MR from the terminal device and the reference measurements in the 3D-fingerprint database. For instance, the similarity calculation may be performed for cell ID, beam angle, MR height/width/depth coordinates with the corresponding fingerprint in the database. According to the fitting results based on the similarity calculation, the location server can determine a 3D-fingerprint position of the terminal device, for example, by outputting the 3D-position coordinate of the terminal device. In the case that a Bayesian network is used, the Bayesian network can be input with for example, cell ID, beam angle, MR height/width/depth coordinates and can output several reference positions ranked by probabilities. Optionally, the 3D-fingerprint position may be integrated with best performance among various positioning algorithms such as observed time difference of arrival/uplink time difference of arrival/enhanced cell ID (OTDOA/UTDOA/ECID).

Alternatively, in the case that the location request is initiated for a terminal device such as an IoT terminal which does not support MIMO communication, as shown in block 508, the location server may further inquire the specific category of the terminal device. In accordance with an exemplary embodiment, the location server can determine whether this IoT terminal can support sidelink or other D2D communications, as shown in block 510. If the IoT terminal can establish a D2D communication with another terminal device (such as an eMBB/NR terminal), as shown in block 512, the location server can determine the location of this IoT terminal by utilizing the D2D communication. Alternatively, if the IoT terminal does not support D2D communication, as shown in block 514, the location server may deal with this IoT terminal as a CAT-M/CAT-I or NB-IoT terminal without D2D capability.

In the case that the location request is initiated for a terminal device such as an IoT terminal which can support D2D communication, the location server can utilize measurements reported by the NR/eMBB terminals which are able to establish D2D communications with this IoT terminal. It can be realized that the IoT terminal may comprise a NB-IoT/CAT-M terminal which can connect to a serving cell through a sidelink or D2D communication with a UE (such as a NR/eMBB terminal). As such, the UE can act as a relay for the IoT terminal via the sidelink. It will be appreciated that the D2D communication may involve not only sidelink but also Bluetooth (BT) or WLAN, which can be supported by both the eMBB terminal and the IoT terminal. The relaying feature of UE can deal with IoT terminals deployed deeply so that conventional positioning method cannot be performed.

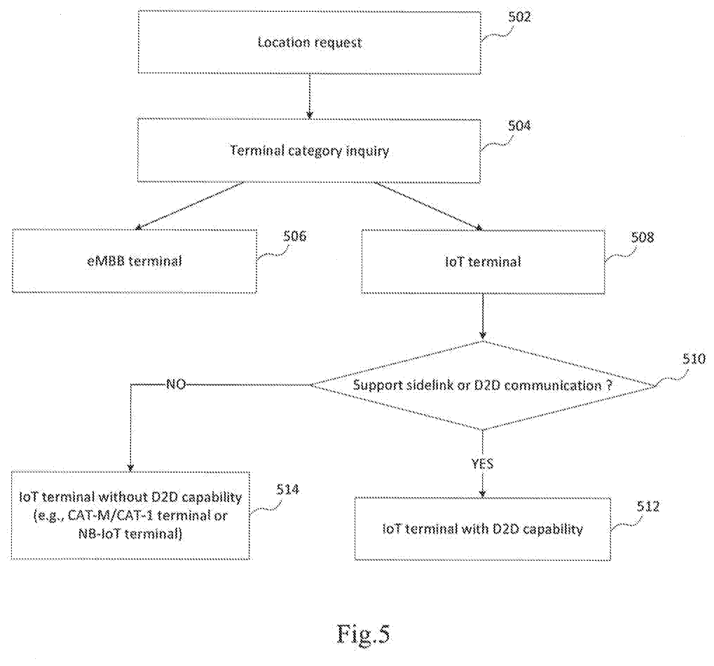

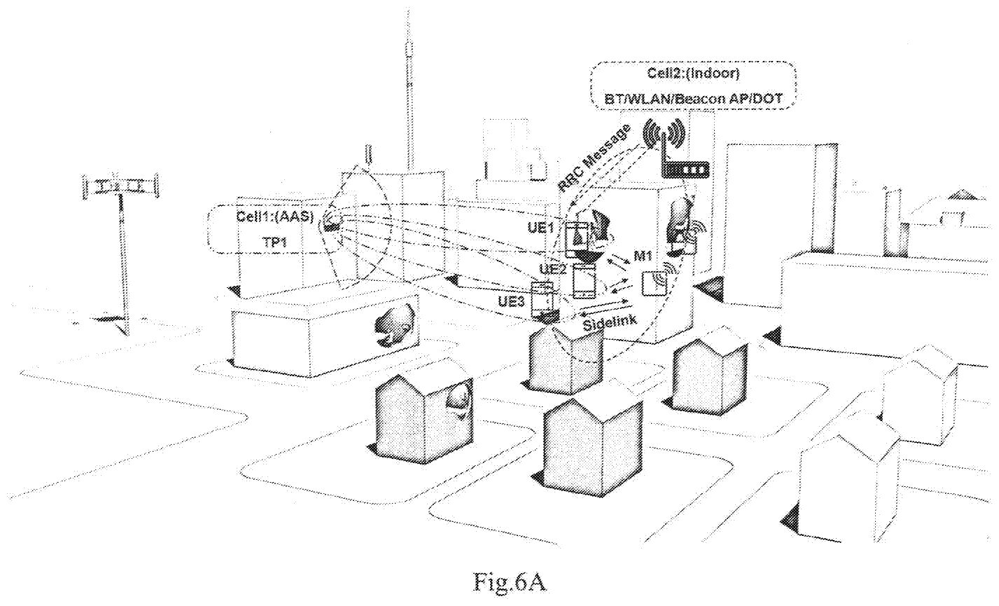

FIG. 6A is a diagram illustrating an exemplary scenario for positioning a terminal device with D2D communication capability according to some embodiments of the present disclosure. In the exemplary scenario shown in FIG. 6A, UE1, UE2 and UE3 may be served by Cell1 at TP1 where AAS is deployed. Alternatively or additionally, UE1, UE2 and UE3 may also be served by Cell2 which is configured by the indoor communication system such as BT/WLAN/Beacon AP/DOT. According to an exemplary embodiment, UE1, UE2 and UE3 may comprise NR/eMBB terminals which can support MIMO communications. On the other hand, UE1, UE2 and UE3 can act as relays for M1 via the sidelink or D2D communication. M1 may comprise an IoT terminal such as a NB-IoT/CAT-M terminal which has the sidelink or D2D communication capability. In accordance with an exemplary embodiment where a location request is initiated for M1, a location server can utilize some measurements reported by one or more of UE1, UE2 and UE3 to process the location request for positioning M1.

FIG. 6B is a diagram illustrating an exemplary signaling procedure for positioning a terminal device with D2D communication capability according to some embodiments of the present disclosure. The exemplary signaling procedure may involve some network elements, for example, UE1/UE2/UE3, M1 and Cell2 as shown in FIG. 6A and a location server such as LMF which can provide LCS to various terminals in the network. It will be appreciated that signaling messages and network elements shown in FIG. 6B are just as examples, and more or less alternative signaling messages and network elements may be involved in the exemplary procedure.

According to the procedure as illustrated in FIG. 6B, the location server may send a 3D-LCS request to Cell2 in step 601. The 3D-LCS request may be initiated for M1 by the location server or any other devices or applications which may need to know the location of M1. in response to the 3D-LCS request, Cell2 which is configured as the serving cell of M1 can perform reconfiguration of M1 in step 602. The reconfiguration of M1 may be provisioned to one or more candidate devices (e.g., UE1, UE2 and UE3) via RRC signaling. The one or more candidate devices are able to support D2D communication with M1 and can be selected by Cell2 according to a predefined criterion, for example, within a specific region around M1. The reconfiguration of M1 by Cell2 can enable UE1, UE2 and UE3 to exchange information with M1 via D2D communication. As shown in steps 603 and 604 of FIG. 6B, M1 may transmit statistical channel state information-reference signal (CSI-RS) in band 1, and receive transmission of channel state information at transmitter (CSIT) from at least one of UE1, UE2 and UE3 in band 2. In steps 605-607, Cell2 may receive MRs for M1 via UE1, UE2 and UE3, respectively, and forward the received MRs to the location server in step 608.

In accordance with an exemplary embodiment, the MR provided by each candidate UE (such as UE1-UE3) for 3D-fingerprint positioning of M1 may include cell ID, beam angle, MR height/width/depth coordinates. The location server can derive the 3D-fingerprint of each candidate UE by performing similarity calculation between the reported measurements and reference measurements in the 3D-fingerprint database, based at least in part on the MR from the candidate UE. Then the location server can calculate the 3D-fingerprint of M1 according to the fitting results from the 3D-fingerprints derived for UE1, UE2 and UE3. Optionally, weight calculation may be applied for determining the fingerprint of M1 based on the 3D-fingerprints of UE1, UE2 and UE3, for example, by using k-nearest neighbor (KNN) or weighted k-nearest neighbor (WKNN) algorithms, etc. According to an exemplary embodiment, the link budget gap between the fingerprint of M1 and the 3D-fingerprint can be estimated by coverage extension (CE) level (e.g., via RRC signaling) and band pathloss (e.g., via the pathloss model).

In the case that the location request is initiated for a terminal device such as an IoT terminal without D2D capability, similarity calculation between the reported measurements and the reference measurements in the 3D-fingerprint database cannot be directly performed by the location server, because the pathloss model available for an eMBB terminal may be inapplicable to transmission configurations (e.g., SS in the measurement bandwidth, receiver sensitivity, pathloss, power setting etc.) related to the IoT terminal. On the other hand, the IoT terminal without D2D capability may not be able to collect sufficient measurement information on cell, beam and even radio signals due to its limited functionality. In this case, the measurement information reported by this IoT terminal may not be enough for the location server to find out the corresponding 3D-fingerprint in the database. Optionally, the location server can make a normal CAT-M positioning with WLAN/Beacon or indoor ECID/fingerprint location. If 3D-LCS is requested for the IoT terminal (such as a CAT-M/NB-IoT terminal without D2D capability, or any other possible machine-type terminal), the location server can derive the 3D-fingerprint of the CAT-M/NB-IoT terminal by performing a fingerprint conversion based on the 3D-fingerprints of eMBB terminals.

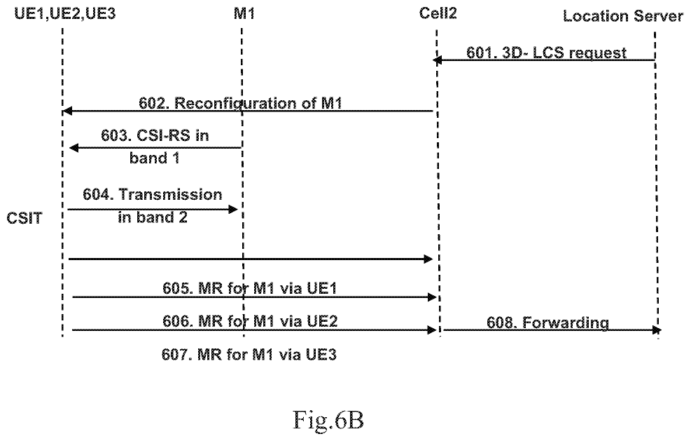

FIG. 7 is a diagram illustrating an exemplary scenario for positioning a terminal device without D2D communication capability according to some embodiments of the present disclosure. In the exemplary scenario shown in FIG. 7, UE1, UE2 and UE3 may be served by Cell1 at TP1 where the AAS is deployed, M1, M2 and M3 may be served by Cell2 which is configured by the indoor communication system such as BT/WLAN/Beacon AP/DOT, and UE4, UE5 and M4-M6 may be served by Cell3 which is configured by the LTE system. According to an exemplary' embodiment, UE1, UE2, UE3, UE4 and UE5 may comprise NR/eMBB terminals which can support MIMO communications. M1-M6 may comprise machine-type terminals such as CAT-M/NB-IoT terminals without D2D capability.

In accordance with an exemplary embodiment, the location server can set up a fingerprint conversion with machine learning, for example, supervised clustering, sparse dictionary' learning, etc. Specifically, the location server can generate statistics of the pathloss gap between CAT-M/NB-IoT terminals and eMBB terminals connected in E-UTRAN through the same TP ID with linear regression. The regression may occur only when a MR and/or a fingerprint updates. The regression can achieve the beam-independent average gain. According to an exemplary embodiment, in order to generate the statistics of the pathloss gap, the location server can utilize the historic MRs of some UEs which are served by LTE/Indoor AP while measured by AAS, for example, dual connectivity (DC) or carrier aggregation (CA) or single carrier terminals. These UEs can assist in providing both 3D-fingerprints and indoor measurements including SS and same cell ID with machine-type terminals. As an example, the statistics of the pathloss gap with linear regression may be stored in a database as follows:

| | |
|---|---|
| Cell ID: | X |
| TP ID/AAS ID: | Z |
| Beam ID: | 0 |
| Pathloss regression Gap(dB): | RSRP, SINR, RSRQ(note) . . . |
| Beam ID: | 1 |
| Pathloss regression Gap(dB): | RSRP, SINR, RSRQ(note) . . . |
| Beam ID: | m . . . |

Note:
RSRQ value need to be considered in the same measurement bandwidth.

Optionally, the setup of the fingerprint conversion may be performed based at least in part on calculations of the offset of RSRP/RSRQ/SINR between M2M and LTE and the pathloss gap between NR FR1/FR2 and legacy frequency, by using an environment model like Hata model or a 3D-model including the AAS beamforming gain. In accordance with an exemplary embodiment, the statistics of the pathloss gap between CAT-M/NB-IoT terminals and eMBB terminals can be utilized to generate compensations to the measurements of the CAT-M/NB-IoT terminal, so as to implement the conversion from a CAT-M/NB-IoT terminal fingerprint to a valid eMBB terminal fingerprint. Then the location server can calculate similarity between the compensated measurements and the reference measurements in the 3D-fingerprint database, and determine the 3D-fingerprint of the CAT-M/NB-IoT terminal correspondingly.

In accordance with an exemplary embodiment, the determined 3D-fingerprint of the CAT-M/NB-IoT terminal may be obtained by fitting from SS and optionally antenna gain, pathloss gain and frequency band loss. Taking the scenario in FIG. 7 as an example, based on the similarity calculation in indoor AP or a M2M serving cell, the positioning results of M1-M3 may comprise fitting results including height, depth, width and SS which are reported by UE1-UE3 in Cell1. Similarly, the positioning results of M4-M6 may comprise fitting results containing height, depth, width and SS which are reported by UE4-UE5.

It is noted that some embodiments of the present disclosure are mainly described in relation to LTE or NR specifications being used as non-limiting examples for certain exemplary network configurations and system deployments. As such, the description of exemplary embodiments given herein specifically refers to terminology which is directly related thereto. Such terminology is only used in the context of the presented non-limiting examples and embodiments, and does naturally not limit the present disclosure in any way. Rather, any other system configuration or radio technologies may equally be utilized as long as exemplary embodiments described herein are applicable.

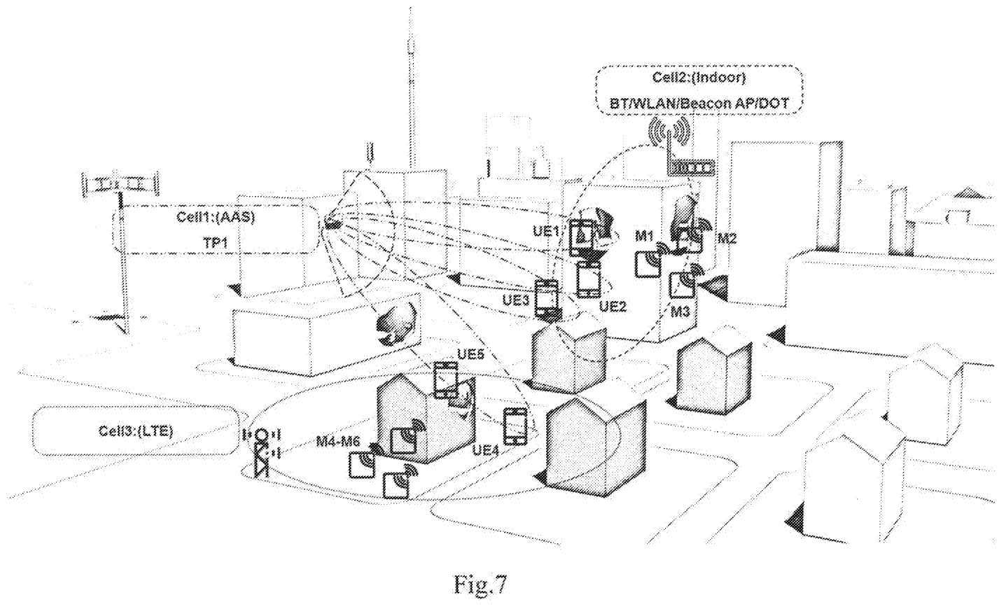

FIG. 8 is a flowchart illustrating a method 800 according o some embodiments of the present disclosure. The method 800 illustrated in FIG. 8 may be performed by an apparatus implemented in a network node or communicatively coupled to a network node. In accordance with an exemplary embodiment, the network node may comprise a location server such as LMF/SMLC. The location server can provide LCS to a terminal device such as eMBB terminal, IoT terminal, etc. The information in a MR of the terminal device may be forwarded to the location server by a base station serving the terminal device. Optionally, the base station serving the terminal device may be configured to operate as the location server.

According to the exemplary method 800 illustrated in FIG. 8, the network node can obtain first measurement information for positioning a terminal device, as shown in block 802. In accordance with an exemplary embodiment, the first measurement information may be obtained based at least in part on measurements in a MR transmitted by the terminal device. The network node can identify a match with the first measurement information from reference data, as shown in block 804. The reference data may comprise, for each of a plurality of predefined locations, second measurement information which is collected for a reference device by using multi-antenna technology. For example, the reference device may be configured to support: multi-antenna communication and can report: measurements on signal strength and beamforming which may be collected with the multi-antenna technology.

In accordance with some exemplary embodiments, the reference data may indicate corresponding 3D position coordinates for each of the plurality of predefined locations. In addition, the second measurement information associated with each of the plurality of predefined locations may comprise signal strength information and beam information related to the reference device. According to an exemplary embodiment, the reference data may be generated or maintained according to a sparse dictionary learning scheme. Optionally, the reference data may be updated based at least in part on positioning measurements collected from one or more communication networks. As an example, the reference data may comprise 3D-fingerprints of different RPs stored in a database. The 3D-fingerprints in the database may be at least partly dependent on fingerprints from one or more of LTE/3G/WLAN/Bluetooth systems.

In accordance with some exemplary embodiments, the identification of the match with the first measurement information may be performed by similarity calculation as described in connection with FIGS. 2-4. Optionally, the network node can identify the second measurement information matched with the first measurement information by using a probabilistic graphical model such as a Bayesian network. Based at least in part on the second measurement information matched with the first measurement information, the network node can determine a 3D position of the terminal device, as shown in block 806. According to an exemplary embodiment, the determination of the 3D position of the terminal device may be optimized according to two or more positioning algorithms.

In accordance with an exemplary embodiment, the terminal device may be configured to support multi-antenna communication. For example, the terminal device may comprise a NR/eMBB terminal supporting MIMO. In this case, the first measurement information may comprise signal strength information and beam information reported by the terminal device. The network node can directly use the first measurement information to find the matched second measurement information from the reference data, for example, by similarity calculation.

In accordance with an exemplary embodiment, the terminal device may be configured to support machine type communication with a serving cell. For example, the terminal device may comprise an IoT terminal without D2D communication capability, such as M1-M6 in FIG. 7. In this case, the first measurement information may comprise signal strength information and beam information which can be generated by the network node according to measurements of the terminal device. For example, the measurements of the terminal device may comprise SS and/or pathloss measurements. The signal strength information and the beam information in the first measurement information can be generated according to the offset of signal strength and/or the statistics of the pathloss gap between IoT terminals and eMBB terminals, as described with respect to FIG. 7.

In accordance with an exemplary embodiment where the terminal device is configured to operate as a machine type terminal, the network node can obtain the first measurement information at least by determining compensations for the measurements of the terminal device, based at least in part on signal strength information and beam information reported by one or more neighboring devices (such as UE4-UE5 in FIG. 7) of the terminal device (such as M4-M6 in FIG. 7) in the serving cell. By applying the compensations to the measurements of the terminal device, the network node can generate the first measurement information for positioning the terminal device.

In accordance with some exemplary embodiments, the network node can identify the second measurement information matched with the first measurement information by calculating, for at least one of the plurality of predefined locations, a similarity between the second measurement information and the first measurement information. Based at least in part on a result of the calculation, the network node can determine the second measurement information matched with the first measurement information. The 3D position of the terminal device may be indicated by 3D position coordinates which are corresponding to the second measurement information matched with the first measurement information.

In accordance with an exemplary embodiment, the terminal device may be configured to support D2D communication with one or more candidate devices which are configured to support multi-antenna communication with a serving cell. Among the one or more candidate devices, any candidate device may be operable as a relay to enable the terminal device to communicate with the serving cell. For example, the terminal device may comprise an IoT terminal with sidelink or D2D communication capability, such as M1 in FIG. 6A. The one or more candidate devices may comprise NR/eMBB terminals with MIMO and D2D capabilities, such as UE1-UE3 in FIG. 6A. In this case, the first measurement information may comprise one or more groups of measurements and each group of measurements may comprise signal strength information and beam information reported by a candidate device being selected from the one or more candidate devices.

In accordance with an exemplary embodiment where the terminal device is configured to operate as an IoT terminal with D2D communication capability, the positioning of the terminal device may be implemented with assistance of one or more candidate devices selected by the network node and/or the serving cell of the terminal device. According to the exemplary embodiment, the network node can obtain the first measurement information by sending to the serving cell a request for positioning the terminal device. The request can enable the serving cell to trigger the D2D communication between the terminal device and the selected candidate device and the report of signal strength information and beam information to the serving cell by the selected candidate device. The signal strength information and the beam information reported by the selected candidate device (such as UE1/UE2/UE3 in FIGS. 6A-6B) may be forwarded to the network node (such as the location server in FIGS. 6A-6B) from the serving cell (such as Cell2 in FIGS. 6A-6B). Thus, the network node can receive the first measurement information for positioning the terminal device from the serving cell.

According to an exemplary embodiment, the network node may calculate, for at least one of the plurality of predefined locations, a similarity between the second measurement information and each group of measurements in the first measurement information. Based at least in part on a result of the similarity calculation, the network node can determine the second measurement information matched with each group of measurements in the first measurement information. In order to determine the 3D position of the terminal device, the network node can get, from the reference data, 3D position coordinates which are corresponding to the second measurement information matched with each group of measurements. The 3D position coordinates got from the reference data may be processed by the network node according to a predefined criterion to derive the 3D position of the terminal device. For example, the 3D position of the terminal device may be a result derived from the 3D position coordinates associated with two or more candidate devices applying different weights.

The proposed solution according to one or more exemplary embodiments can enable a network node such as a location server to provide LCS to a terminal device by exploiting data from 3D fingerprinting technique via the AAS or beamforming antennas. In some exemplary embodiments, machine learning of 3D-fingerprints may be performed to accelerate the calculation process for positioning the terminal device. According to the proposed solution, 3D-fingerprints of eMBB terminals may be utilized to provide an accurate height and/or 3D-coordinates for an IoT device, especially in deep coverage. For NR or LTE terminals such as eMBB and IoT terminals with D2D communication capability, the proposed solution can improve passive location accuracy and user experience. On the other hand, the positioning of NB-IoT or CAT-M terminals can also be implemented by the passive LCS, without setup of a huge fingerprint database for IoT terminals having no D2D communication capability.

The various blocks shown in FIG. 2, FIG. 5 and FIG. 8 may be viewed as method steps, and/or as operations that result from operation of computer program code, and/or as a plurality of coupled logic circuit elements constructed to carry out the associated function(s). The schematic flow chart diagrams described above are generally set forth as logical flow chart diagrams. As such, the depicted order and labeled steps are indicative of specific embodiments of the presented methods. Other steps and methods may be conceived that are equivalent in function, logic, or effect to one or more steps, or portions thereof, of the illustrated methods. Additionally, the order in which a particular method occurs may or may not strictly adhere to the order of the corresponding steps shown.

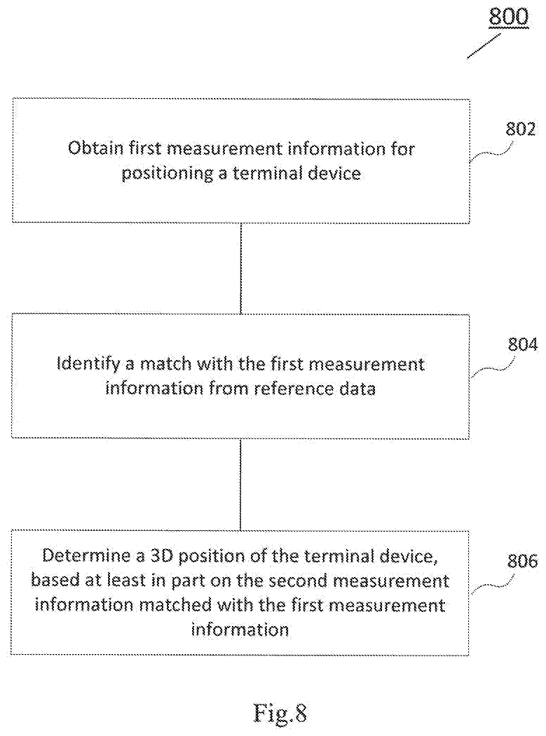

FIG. 9 is a block diagram illustrating an apparatus 900 according to some embodiments of the present disclosure. As shown in FIG. 9, the apparatus 900 may comprise one or more processors such as processor 901 and one or more memories such as memory 902 storing computer program codes 903. The memory 902 may be non-transitory machine/processor/computer readable storage medium. In accordance with some exemplary embodiments, the apparatus 900 may be implemented as an integrated circuit chip or module that can be plugged or installed into a network node as described with respect to FIG. 8.

In some implementations, the one or more memories 902 and the computer program codes 903 may be configured to, with the one or more processors 901, cause the apparatus 900 at least to perform any operation of the method as described in connection with FIG. 8. Alternatively or additionally, the one or more memories 902 and the computer program codes 903 may be configured to, with the one or more processors 901, cause the apparatus 900 at least to perform more or less operations to implement the proposed methods according to the exemplary embodiments of the present disclosure.

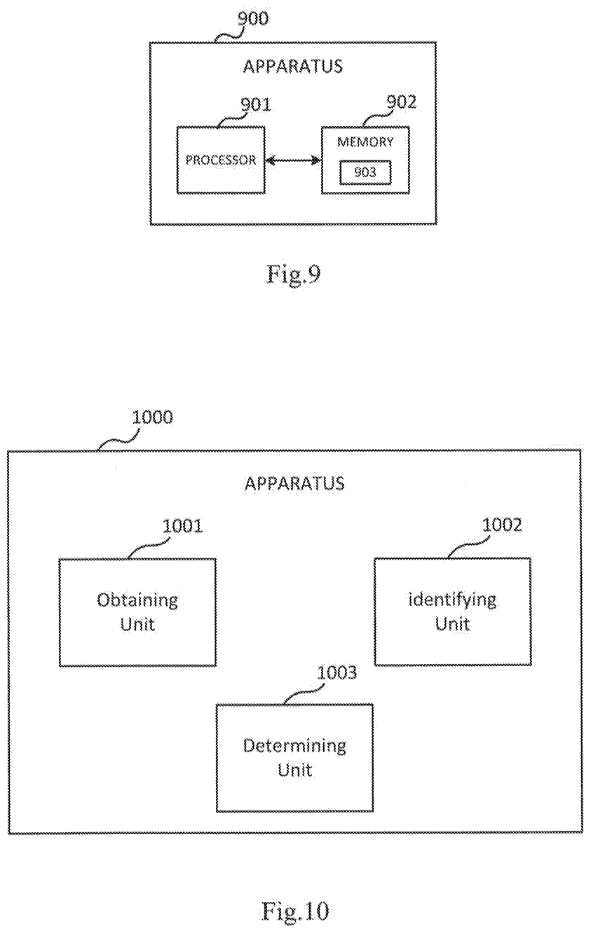

FIG. 10 is a block diagram illustrating an apparatus 1000 according to some embodiments of the present disclosure. As shown in FIG. 10, the apparatus 1000 may comprise an obtaining unit 1001, an identifying unit 1002 and a determining unit 1003. In an exemplary embodiment, the apparatus 1000 may be implemented in a network node such as a location server. The obtaining unit 1001 may be operable to carry out the operation in block 802, the identifying unit 1002 may be operable to carry out the operation in block 804, and the determining unit 1003 may be operable to carry out the operation in block 806. Optionally, the obtaining unit 1001, the identifying unit 1002 and/or the determining unit 1003 may be operable to early out more or less operations to implement the proposed methods according to the exemplary embodiments of the present disclosure.

In general, the various exemplary embodiments may be implemented in hardware or special purpose chips, circuits, software, logic or any combination thereof. For example, some aspects may be implemented in hardware, while other aspects may be implemented in firmware or software which may be executed by a controller, microprocessor or other computing device, although the disclosure is not limited thereto. While various aspects of the exemplary embodiments of this disclosure may be illustrated and described as block diagrams, flow charts, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

As such, it should be appreciated that at least some aspects of the exemplary embodiments of the disclosure may be practiced in various components such as integrated circuit chips and modules. It should thus be appreciated that the exemplary embodiments of this disclosure may be realized in an apparatus that is embodied as an integrated circuit, where the integrated circuit may comprise circuitry (as well as possibly firmware) for embodying at least one or more of a data processor, a digital signal processor, baseband circuitry and radio frequency circuitry that are configurable so as to operate in accordance with the exemplary embodiments of this disclosure.

It should be appreciated that at least some aspects of the exemplary embodiments of the disclosure may be embodied in computer-executable instructions, such as in one or more program modules, executed by one or more computers or other devices. Generally, program modules include routines, programs, objects, components, data structures, etc. that perform particular tasks or implement particular abstract data types when executed by a processor in a computer or other device. The computer executable instructions may be stored on a computer readable medium such as a hard disk, optical disk, removable storage media, solid state memory, random access memory (RAM), etc. As will be appreciated by one of skill in the art, the function of the program modules may be combined or distributed as desired in. various embodiments. In addition, the function may be embodied in whole or partly in firmware or hardware equivalents such as integrated circuits, field programmable gate arrays (FPGA), and the like.

The present disclosure includes any novel feature or combination of features disclosed herein either explicitly or any generalization thereof. Various modifications and adaptations to the foregoing exemplary embodiments of this disclosure may become apparent to those skilled in the relevant arts in view of the foregoing description, when read in conjunction with the accompanying drawings. However, any and all modifications will still fall within the scope of the non-limiting and exemplary embodiments of this disclosure.

1. A method implemented at a network node, comprising:
obtaining first measurement information for positioning a terminal device;
a match with the first measurement information from reference data, wherein the reference data comprises, for each of a plurality of predefined locations, second measurement information which is collected for a reference device by using multi-antenna technology; and
determining a three-dimensional position of the terminal device, based at least in part on the second measurement information matched with the first measurement information.

2. The method according to claim 1, wherein for each of the plurality of predefined locations, the reference data indicates corresponding three-dimensional position coordinates and the second measurement information comprises signal strength information and beam information related to the reference device.

3. The method according to claim 1, wherein the terminal device is configured to support multi-antenna communication.

4. The method according to claim 3, wherein the first measurement information comprises signal strength information and beam information reported by the terminal device.

5. The method according to claim 1, wherein the terminal device is configured to support machine type communication with a serving cell.

6. The method according to claim 5, wherein the first measurement information comprises signal strength information and beam information which are generated by the network node according to measurements of the terminal device.

7. The method according to claim 6, wherein the first measurement information is obtained by:
determining compensations for the measurements of the terminal device, based at least in part on signal strength information and beam information reported by one or more neighboring devices of the terminal device in the serving cell; and
generating the first measurement information by applying the compensations to the measurements of the terminal device.

8. The method according to claim 1, wherein the second measurement information matched with the first measurement information is identified by:
calculating, for at least one of the plurality of predefined locations, a similarity between the second measurement information and the first measurement information; and
determining the second measurement information matched with the first measurement information, based at least in part on a result of the calculation.

9. The method according to claim 1, wherein the three-dimensional position of the terminal device is indicated by three-dimensional position coordinates which are corresponding to the second measurement information matched with the first measurement information.

10. The method according to claim 1, wherein the terminal device is configured to support device-to-device communication with one or more candidate devices which are configured to support multi-antenna communication with a serving cell, and wherein any of the one or more candidate devices is operable as a relay to enable the terminal device to communicate with the serving cell.

11. The method according to claim 10, wherein the first measurement information comprises one or more groups of measurements and each group of measurements comprises signal strength information and beam information reported by a candidate device being selected from the one or more candidate devices.

12. The method according to claim 11, wherein the first measurement information is obtained by:
sending to the serving cell a request for positioning the terminal device, wherein the request enables the serving cell to trigger the device-to-device communication between the terminal device and the selected candidate device and the report of signal strength information and beam information to the serving cell by the selected candidate device; and
receiving the first measurement information from the serving cell.

13. The method according to claim 11, wherein the second measurement information matched with the first measurement information is identified by:
calculating, for at least one of the plurality of predefined locations, a similarity between the second measurement information and each group of measurements in the first measurement information; and
determining the second measurement information matched with each group of measurements in the first measurement information, based at least in part on a result of the calculation.

14. The method according to claim 13, wherein the three-dimensional position of the terminal device is determined by:
getting, from the reference data, three-dimensional position coordinates which are corresponding to the second measurement information matched with each group of measurements; and
processing the three-dimensional position coordinates according to a predefined criterion to derive the three-dimensional position of the terminal device.

15. The method according to claim 1, wherein the reference data is maintained according to a sparse dictionary learning scheme.

16. The method according to claim 1, wherein the second measurement information matched with the first measurement information is identified by using a probabilistic graphical model.

17. The method according to claim 1, wherein the reference data is updated based at least in part on positioning measurements collected from one or more communication networks.

18. The method according to claim 1, wherein the determination of the three-dimensional position of the terminal device is optimized according to two or more positioning algorithms.

19. An apparatus implemented in a network node, comprising:
one or more processors; and
one or more memories comprising computer program codes,
the one or more memories and the computer program codes configured to, with the one or more processors, cause the apparatus at least to:
obtain first measurement information for positioning a terminal device;
identify a match with the first measurement information from reference data, wherein the reference data comprises, for each of a plurality of predefined locations, second measurement information which is collected for a reference device by using multi-antenna technology; and
determine a three-dimensional position of the terminal device, based at least in part on the second measurement information matched with the first measurement information.

20. The apparatus according to claim 19, wherein for each of the plurality of predefined locations, the reference data indicates corresponding three-dimensional position coordinates and the second measurement information comprises signal strength information and beam information related to the reference device.

21. (canceled)

22. (canceled)
